(19) United States
(12) Patent Application Publication
(10) Pub. No.: US 2016/0188292 A1
(43) Pub. Date: Jun. 30, 2016

(54) SYSTEM AND METHOD FOR INTERPRETING NATURAL LANGUAGE INPUTS BASED ON STORAGE OF THE INPUTS

(71) Applicant: VoiceBox Technologies Corporation, Bellevue, WA (US)

(72) Inventors: Daniel B. CARTER, REDMOND, WA (US); Michael R. KENNEWICK, JR., Bellevue, WA (US)

(73) Assignee: VoiceBox Technologies Corporation, Bellevue, WA (US)

(21) Appl. No.: 14/980,192

(22) Filed: Dec. 28, 2015

Related U.S. Application Data
(60) Provisional application No. 62/097,874, filed on Dec. 30, 2014.

(51) Int. Cl. G06F 3/16; G10L 15/18; G10L 15/197; G10L 15/22

(52) U.S. Cl. CPC G06F 3/167; G10L 15/22; G10L 15/1822; G10L 15/197; G10L 2015/223; G10L 2015/227

(57) ABSTRACT

In certain implementations, a system and method for interpreting natural language inputs based on storage of the inputs is provided. A natural language input of a user may be obtained. The natural language input may be obtained via an input mode. The natural language input may be processed to determine a first interpretation of the natural language input. The natural language input may be stored based on a data format associated with the input mode. The natural language input may be obtained from storage. The natural language input obtained from storage may be reprocessed to determine a second interpretation of the natural language input.

### CROSS REFERENCE TO RELATED APPLICATION

This application claims the benefit of U.S. Provisional Patent Application Ser. No. 62/097,874 filed Dec. 30, 2014 entitled “SYSTEM AND METHOD FOR INTERPRETING NATURAL LANGUAGE INPUTS BASED ON STORAGE OF THE INPUTS,” the entirety of which is incorporated herein by reference.

### FIELD OF THE INVENTION

The invention relates to systems and methods of interpreting natural language inputs based on storage of the inputs.

### BACKGROUND OF THE INVENTION

Electronic user devices have emerged to become nearly ubiquitous in the everyday lives of many people. One of the reasons for this increased use is the convenience of requesting information with a user device, for example, via personal assistant software capable of processing natural language input. In many cases, however, an initial interpretation of a user input may be inaccurate or inadequate. Typically, another interpretation of the user input may be generated using intermediate results of the initial processing (from which the initial interpretation was generated). However, a subsequent interpretation of the user input generated from the intermediate results of the initial processing may include inaccuracies of the initial interpretation that was derived from the intermediate results. These and other drawbacks exist.

### SUMMARY OF THE INVENTION

The invention relates to systems and methods for interpreting natural language inputs based on storage of the inputs.

In an implementation, one or more user inputs of a user may be processed to determine one or more interpretations of the user input. As an example, if the user input is a natural language utterance spoken by a user, the natural language utterance may be processed to recognize one or more words of the natural language utterance. The recognized words may then be processed, along with context information associated with the user, by a natural language processing engine to determine an interpretation of the user input.

The user inputs may be stored for further processing or later use. For example, user input data associated with a received user input may be stored in storage (e.g., local cache) so that the user input may be accessible for further processing or later use. As an example, with respect to auditory input, an audio file associated with an audio stream captured by an auditory input device may be stored in cache as user input data for further processing. Following storage of the audio file, the audio file may be retrieved for further processing or later use.

In an implementation, the user inputs may be reprocessed to determine one or more reinterpretations of the user inputs. For example, rather than relying on intermediate results from a prior processing of a user input, the original user input (e.g., stored in accordance with a data format associated with a user input mode via which the user input was received) may be obtained from storage and reprocessed to determine a subsequent interpretation of the user input.

In an implementation, a confidence score for the initial interpretation and reinterpretation may be generated representing the likelihood of interpretations of the user input being correct or accurate. In one implementation, the confidence scores of the initial interpretation and the reinterpretation of the user input may be compared to determine which of the initial interpretation or the reinterpretation (or other interpretation) is the most probable interpretation of the user input.

### BRIEF DESCRIPTION OF THE DRAWINGS

FIG. 1 illustrates a system for interpreting natural language inputs based on storage of the inputs, in accordance with an implementation of the invention.

FIG. 2 illustrates a system for facilitating natural language processing, in accordance with an implementation of the invention.

FIG. 3 illustrates a data flow for a process of interpreting natural language inputs based on storage of the inputs, in accordance with an implementation of the invention.

FIG. 4 illustrates a flow diagram for a method of interpreting natural language inputs based on storage of the inputs, in accordance with an implementation of the invention.

FIG. 5 illustrates a flow diagram for a method of determining whether to obtain and/or process a stored natural language input to further interpret (or reinterpret) the input, in accordance with an implementation of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

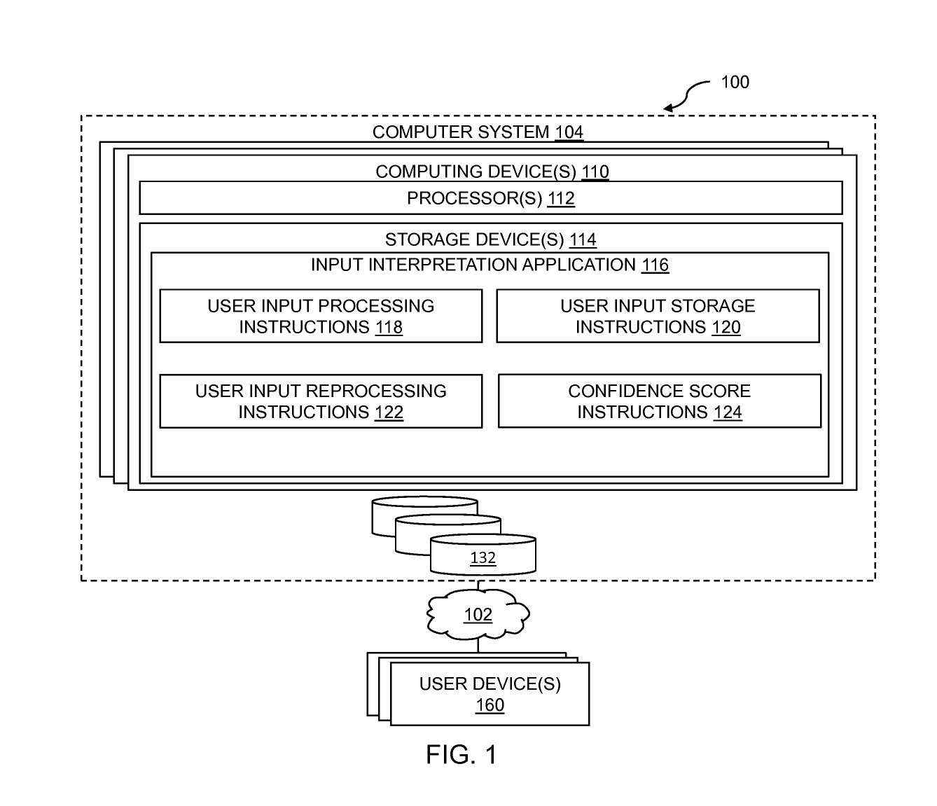

FIG. 1 illustrates a system 100 for interpreting natural language inputs based on storage of the inputs. As an example, system 100 may receive and process a user input to determine one or more interpretations of the user input. The user input may be stored (e.g., in a local cache) for later use, for example, in the event that the user input is to be reprocessed to further interpret or reinterpret the user input. Upon such event, system 100 may obtain the user input from storage and reprocess the user input (obtained from storage) to determine one or more additional interpretations (or reinterpretations) of the user input.

In an implementation, user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. In an implementation, upon receipt of a user input via an input mode, the user input may be stored based on a data format (e.g., recording format, file format, content format, etc.) associated with the input mode (e.g., a data format for storing data associated with inputs received via the input mode) so that, in the event that the user input is to be reprocessed, the user input may later be obtained from storage and reprocessed based on the data format associated with the input mode. As an example, a user input received via a microphone may be stored based on an audio format, a user input received via a camera may be stored based on a video or image format, etc.

In one use case, if a user input is a natural language utterance spoken by a user (and received via a microphone), the utterance may be processed by a speech recognition engine to recognize one or more words of the utterance. The recognized words may then be processed, along with context information associated with the user, by a natural language processing engine to determine an interpretation of the utterance. The utterance may also be stored as an audio file in a cache. If the initial interpretation of the utterance does not satisfy a threshold confidence score, the audio file may be obtained from the cache and processed by the speech recognition engine (or other speech recognition engine) to recognize one or more words of the audio file (e.g., using an updated version of an acoustic model used for the initial recognition process, using an updated version of a language model used for the initial recognition process, etc.). The recognized audio-data-file words may then be processed, along with context information associated with the user (e.g., different from or the same as the context information used for the initial natural language processing), by the natural language processing engine (or other natural language processing engine) to determine a further interpretation (or reinterpretation) of the utterance.

The recognized audio-data-file words (processed by the natural language processing engine) may be the same as or different from the initially-recognized words. As an example, the recognized audio-data-file words and the initially-recognized words may be different as a result of: (i) updating the models used for the initial recognition process; (ii) using models representing a language, dialect, or region different from a language, dialect, or region represented by the models used for the initial recognition process; or (iii) other differences between the initial recognition process and the subsequent recognition process. As another example, the recognized audio-data-file words and the initially recognized words may be the same despite differences between the initial recognition process and the subsequent recognition process.

The reinterpretation (or further interpretation) of the utterance may be the same as or different from the initial interpretation of the utterance. As an example, the reinterpretation and the initial interpretation may be the same if the recognized audio-data-file words and the initially-recognized words are the same. As another example, even if the recognized audio-data-file words and the initially-recognized words are the same, the reinterpretation and the initial interpretation may be different as a result of: (i) new or different context information being available or used during the subsequent interpretation process that was not available or used during the initial interpretation process; (ii) input provided by a user (e.g., who spoke the utterance) after the initial interpretation process is already underway or completed; or (iii) other differences between the initial interpretation process and the subsequent interpretation process. As yet another example, the reinterpretation and the initial interpretation may be different if the recognized audio-data-file words and the initially-recognized words are different. As a further example, the reinterpretation and the initial interpretation may be the same despite differences between the initial interpretation process and the subsequent interpretation process.

In one implementation, user input data (or a user input) may be stored for a finite or predetermined amount of time. In another implementation, user input data may also be stored according to one or more replacement rules. For example, user input data may be stored based on times stamps indicating when the data was received or stored. As such, a first-in first-out (FIFO) or a last-in first-out (LIFO) approach may be used. As another example, a least recently used (LRU) approach may be utilized such that user inputs that have been processed or reprocessed more recently than other stored user inputs continue to be stored while one or more of the other stored user inputs may be removed (e.g., deleted, overwritten, etc.).

In one implementation, user input data (or a user input) may be stored in a cache (e.g., cache memory, disk cache, web cache, etc.). The user input data may, for example, be stored in a cache in accordance with one or more replacement rules (e.g., FIFO, LIFO, LRU, random, etc.). In another implementation, user input storage instructions 120 may store user input data in an extended cache. The extended cache may store user input data removed from the cache. For example, the extended cache may store all user input data removed from the cache for a predetermined period of time.

In another implementation, system 100 may generate a confidence score for an initial interpretation of a natural language user input. The confidence score for the initial interpretation may, for example, represent the likelihood of the initial interpretation of the user input being correct. In another implementation, system 100 may also generate a confidence score for a reinterpretation of the user input. The confidence score for the reinterpretation may, for example, represent the likelihood of the reinterpretation of the user input being correct. In one implementation, system 100 may compare the confidence scores of the initial interpretation and the reinterpretation of the user input to determine which of the initial interpretation or the reinterpretation (or other interpretation) is the most probable interpretation of the user input.

Other uses of system 100 are described herein, and still others will be apparent to those having skill in the art. Having described a high level overview of some of the system functions, attention will now be turned to various system components that facilitate these and other functions.

System Components

System 100 may include a computer system 104, one or more databases 132, and/or other components. Computer system 104 may further interface with various interfaces of the user device(s) 160 such that users may interact with computer system 104.

To facilitate these and other functions, computer system 104 may include one or more computing devices 110. Each computing device 110 may include one or more processors 112, one or more storage devices 114, and/or other components.

Processor(s) 112 may be programmed by one or more computer program instructions, which may be stored in storage device(s) 114. The one or more computer program instructions may include, without limitation, an input interpretation application 116. Input interpretation application 116 may include different sets of instructions that each program the processor(s) 112 (and therefore computer system 104) to perform one or more operations described herein. For example, input interpretation application 116 may include user input processing instructions 118, user input storage instructions 120, user input reprocessing instructions 122, confidence score instructions 124, and/or other instructions that program computer system 104.

In some implementations, a given user device 160 may comprise a given computing device 110. As such, the given user device 160 may comprise processor(s) 112 that is programmed with one or more computer program instructions such as user input processing instructions 118, user input storage instructions 120, user input reprocessing instructions 122, confidence score instructions 124, and/or other instructions.

As used hereinafter, for convenience, the foregoing instructions will be described as performing an operation, when, in fact, the various instructions may program processor(s) 112 (and thereafter computer system 104) to perform the operation. It should be appreciated that the various instructions are described individually as discrete sets of instructions by way of illustration and not limitation, as two or more of the instructions may be combined.

User Input Processing

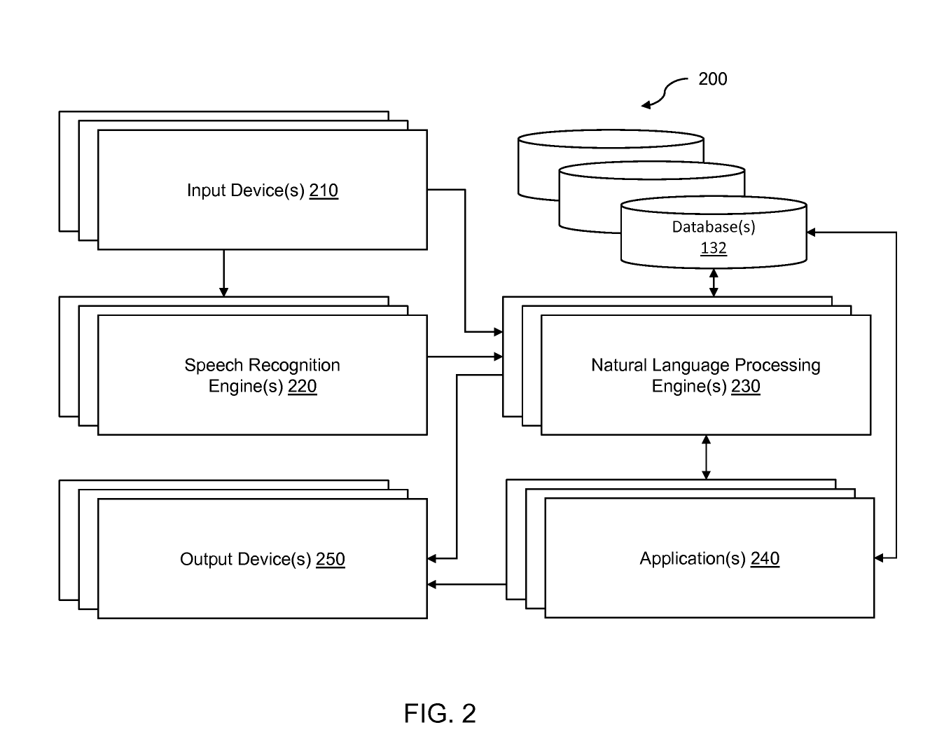

In an implementation, user input processing instructions 118 may process one or more user inputs received from a user to determine one or more interpretations that were intended by the user when the user provided the user inputs. As an example, user input processing instructions 118 may receive and process a user input to determine one or more interpretations of the user input. The user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. In an implementation, user input processing instructions 118 may receive a user input via an input mode. For example, the user input may comprise a data format (e.g., recording format, file format, content format, etc.) associated with an input mode (visual data files, such as video files or image files, representing sign language communication, gestures, or other forms of communication). The user input processing instruction 118 may obtain the user input via the input mode and process the user input to determine one or more interpretations. As described herein elsewhere, user input processing instructions 118 may comprise instructions associated with one or more speech recognition engines (e.g., speech recognition engine(s) 220 of FIG. 2), one or more natural language processing engines (e.g., natural language processing engine(s) 230 of FIG. 2), or other components for processing user inputs to determine user requests related to the user inputs.

In one use case, if the user input is a natural language utterance spoken by a user, the natural language utterance may be processed by a speech recognition engine to recognize one or more words of the natural language utterance. The recognized words may then be processed, along with context information associated with the user, by a natural language processing engine to determine an interpretation of the user input.

FIG. 2 illustrates a system 200 for facilitating natural language processing, in accordance with an implementation of the invention. As shown in FIG. 2, system 200 may comprise input device(s) 210, speech recognition engine(s) 220, natural language processing engine(s) 230, application(s) 240, output device(s) 250, database(s) 132, or other components.

In an implementation, one or more components of system 200 may comprise one or more computer program instructions of FIG. 1 and/or processor(s) 112 programmed with the computer program instructions of FIG. 1. As an example, speech recognition engine(s) 220 and/or natural language processing engine(s) 230 may comprise user input processing instructions 118 or other instructions.

Input device(s) 210 may comprise an auditory input device (e.g., microphone), a visual input device (e.g., camera), a tactile input device (e.g., touch sensor), an olfactory input device, a gustatory input device, a keyboard, a mouse, or other input devices. Input received at input device(s) 210 may be provided to speech recognition engine(s) 220 and/or natural language processing engine(s) 230.

Speech recognition engine(s) 220 may process one or more inputs received from input device(s) 210 to recognize one or more words represented by the received inputs. As an example, with respect to auditory input, speech recognition engine(s) 220 may process an audio stream captured by an auditory input device to isolate segments of sound of the audio stream. The sound segments (or a representation of the sound segments) are then processed with one or more speech models (e.g., acoustic model, lexicon list, language model, etc.) to recognize one or more words of the received inputs. Upon recognition of the words of received inputs, the recognized words may then be provided to natural language processing engine(s) 230 for further processing. In other examples, natural language processing engine(s) 230 may process one or more other types of inputs (e.g., visual input representing sign language communication, gestures, or other forms of communication) to recognize one or more words represented by the other types of inputs.

Natural language processing engine(s) 230 may receive one or more inputs from input device(s) 210, speech recognition engine(s) 220, application(s) 240, database(s) 132, or other components. As an example, natural language processing engine(s) 230 may process inputs received from input device(s) 210, such as user inputs (e.g., voice, non-voice, etc.), location-based inputs (e.g., GPS data, cell ID, etc.), other sensor data input, or other inputs to determine context information associated with one or more user inputs. As another example, natural language processing engine(s) 230 may obtain user profile information, context information, or other information from database(s) 132. The obtained information (or context information determined based on inputs from input device(s) 210) may be processed to determine one or more interpretations associated with one or more user inputs of a user. In yet another example, natural language processing engine(s) 230 may process one or more recognized words from speech recognition engine(s) 220 and other information (e.g., information from input device(s) 210, application(s) 240, and/or database(s) 132) to determine one or more interpretations associated with one or more user inputs of a user.

In an implementation, upon determination of an interpretation of a user, natural language processing engine(s) 230 may determine an application 240 suitable for executing the interpretation, and provide the interpretation to the application for further processing. In one implementation the application 240 may provide one or more interpretations to output device(s) 250 for presentation to the user.

Storing User Input

In accordance with another aspect of the invention, user input storage instructions 120 may store user inputs in a cache, a database, etc. In an implementation, upon receipt of a user input via an input mode, user input storage instructions 120 may store the user input based on a data format (e.g., recording format, file format, content format, etc.) associated with the input mode (e.g., a data format for storing data associated with inputs received via the input mode) so that, in the event that the user input is to be reprocessed, the user input may later be obtained from storage and reprocessed based on the data format associated with the input mode. As an example, a user input received via a microphone may be stored based on an audio format, a user input received via a camera may be stored based on a video or image format, etc. For example, as described in further detail elsewhere herein, user input storage instructions 120 may store user input data (or the user input) for later processing by user input reprocessing instructions 122. Storage of a user input may be performed before, after, or contemporaneously with an initial processing of the user input to determine an interpretation of the user input.

In one use case, after a user input is received by user input interpretation application 116, user input storage instructions 120 may store data associated with the user input based on a data format associated with an input mode in which the user input was received. As an example, with respect to auditory input, user input storage instructions 120 may store an audio stream captured by an auditory input device as an audio file in a cache. As such, when the audio file is needed at a later time to reprocess the user input, user input reprocessing instructions 122 (or other components) may retrieve and process the audio file. In other examples, user input storage instructions 120 may store one or more user input data files based on data formats associated with other input modes (e.g., storing as visual data files, such as video files or image files, representing sign language communication, gestures, or other forms of communication) so that the user inputs represented by the data files may be reprocessed to determine interpretations (or reinterpretations) of the user inputs.

In one implementation, user input storage instructions 120 may store user input data according to one or more replacement rules. For example, user input data may be stored in database(s) 132 for a finite or predetermined amount of time. As another example, user input data may be stored based on times stamps indicating when the data was received or stored. As such, a first-in first-out (FIFO) or a last-in first-out (FIFO) approach may be used. As another example, a least recently used (LRU) approach may be utilized such that user inputs that have been processed or reprocessed more recently than other stored user inputs continue to be stored while one or more of the other stored user inputs may be removed (e.g., deleted, overwritten, etc.).

In one implementation, user input data may be stored in cache (e.g., cache memory, disk cache, web cache, etc.) for temporary storage. When user input data is to be stored in cache and an empty space exists in the cache, the user input data may be stored in the empty space. When an empty space does not exist within the cache, user input data associated with a previously stored user input is removed from the main cache to make room for the user input data associated with the most recently received user input. In another implementation, user input storage instructions 120 may store user input data in an extended cache. The extended cache may store user input data removed from the cache. For example, the extended cache may store all user input data removed from the cache for a predetermined period of time.

In one implementation, user input storage instructions 120 may store user input data at one or more databases 132. For example, computing system 104 as illustrated may include internal database(s) 132 that obtains and stores data associated with a user input received from a user device operated by the user. In another implementation, user input storage instructions 120 may store user input data at one or more external databases. For example, computing system 104 as illustrated may include external database(s) located outside the computing system 104 that obtains and stores data associated with a user input received from a user device operated by the user.

In one implementation, user input storage instructions 120 may store user input data at a server device. For example, computing device 110 as illustrated may include a server device that obtains and stores data associated with a user input received from a user device operated by the user. In another implementation, user input storage instructions 120 may store user input data at a given user device 160. For example, a given user device, such as a given computing device 110, may store data associated with one or more received user inputs.

Reprocessing of User Input

In another implementation, the user input reprocessing instructions 122 may reprocess the one or more user inputs received from a user to determine one or more reinterpretations of the user inputs. In one implementation, user input reprocessing instructions 122 may obtain the stored user input data to reprocess the one or more user inputs. As such, the user input reprocessing instructions 122 may reprocess the original user input provided by the user. It should be appreciated that the reinterpretation of a user input is different from an interpretation of the same user input even though the results of the reinterpretation and interpretation may be the same. As described herein elsewhere, user input reprocessing instructions 122 may comprise instructions associated with one or more speech recognition engines (e.g., speech recognition engine(s) 220 of FIG. 2), one or more natural language processing engines (e.g., natural language processing engine(s) 230 of FIG. 2), or other components for processing user inputs to determine user requests related to the user inputs.

In one implementation, in the event that the user input is to be reprocessed, the user input data may be obtained from storage and reprocessed based on the data format associated with the input mode. As an example, a user input received via a microphone may be stored based on an audio format, a user input received via a camera may be stored based on a video or image format, etc. In one use case, if a user input is a natural language utterance spoken by a user (and received via a microphone), the utterance may be stored as an audio file in a cache. In the event that the user input is to be reprocessed, the audio file may be obtained from the cache and processed by the speech recognition engine (or other speech recognition engine) to determine one or more reinterpretations of the utterance stored in the audio file

In one implementation, user input reprocessing instructions 122 may reprocess the user input data along with the previous interpretation and any profile information, context information, or other information associated with the user input to determine a reinterpretation of the user input. As an example, user input reprocessing instructions 122 obtain user input data associated with an input received from user device, such as user inputs (e.g., voice, non-voice, etc.), and obtain profile information, context information, or other information from database(s) 132. The user input data and obtained information may be reprocessed to determine one or more reinterpretations associated with one or more user inputs of a user

In one implementation, user input reprocessing instructions 122 may reprocess the user input data associated with a user input stored in cache, a database, etc., to determine a reinterpretation of the user input. As an example, if the user input is a natural language utterance spoken by a user, the natural language utterance may be reprocessed to recognize second one or more words of the natural language utterance. The recognized second words may then be reprocessed, along with context information associated with the user, by a natural language processing engine to determine a reinterpretation of the user input.

In one implementation, the reprocessing of user input data associated with one or more user inputs may be triggered according to one or more trigger rules. In one use case, the reprocessing of a user input may be triggered by the passing of a predetermined time period since the previous processing. In another use case, the reprocessing of user input may be triggered by an interpretation not satisfying a threshold confidence score. In another use case, the reprocessing of user input may be triggered by the update of profile and/or context information associated with the user. For example, the update of profile information by a user will trigger a reprocessing of user input made by that user. In another implementation, the reprocessing of user input data associated with one or more user inputs may be triggered by an update of an interpretation model utilized to process the user input. In another implementation, the reprocessing of user input data associated with one or more user inputs may be triggered by the user.

For example, if a user input is a natural language utterance spoken by a user, the recognized words may then be processed to determine an interpretation of the utterance. If the initial interpretation of an utterance does not satisfy a threshold confidence score, the audio file may be obtained from the cache and processed by the speech recognition engine (or other speech recognition engine) to recognize one or more words of the audio file (e.g., using an updated version of an acoustic model used for the initial recognition process, using an updated version of a language model used for the initial recognition process, etc.). The recognized audio-data-file words may then be processed, along with context information associated with the user (e.g., different from or the same as the context information used for the initial natural language processing), by the natural language processing engine (or other natural language processing engine) to determine a further interpretation (or reinterpretation) of the utterance.

The recognized audio-data-file words (processed by the natural language processing engine) may be the same as or different from the initially-recognized words. As an example, the recognized audio-data-file words and the initially-recognized words may be different as a result of: (i) updating the models used for the initial recognition process; (ii) using models representing a language, dialect, or region different from a language, dialect, or region represented by the models used for the initial recognition process; or (iii) other differences between the initial recognition process and the subsequent recognition process. As another example, the recognized audio-data-file words and the initially recognized words may be the same despite differences between the initial recognition process and the subsequent recognition process.

The reinterpretation (or further interpretation) of the utterance may be the same as or different from the initial interpretation of the utterance. As an example, the reinterpretation and the initial interpretation may be the same if the recognized audio-data-file words and the initially-recognized words are the same. As another example, even if the recognized audio-data-file words and the initially-recognized words are the same, the reinterpretation and the initial interpretation may be different as a result of: (i) new or different context information being available or used during the subsequent interpretation process that was not available or used during the initial interpretation process; (ii) input provided by a user (e.g., who spoke the utterance) after the initial interpretation process is already underway or completed; or (iii) other differences between the initial interpretation process and the subsequent interpretation process. As yet another example, the reinterpretation and the initial interpretation may be different if the recognized audio-data-file words and the initially-recognized words are different. As a further example, the reinterpretation and the initial interpretation may be the same despite differences between the initial interpretation process and the subsequent interpretation process.

In an implementation, upon determination of a reinterpretation of a user, user input reprocessing instructions 122 may determine an application suitable for executing the reinterpretation and provide the reinterpretation to the application for further processing. In one implementation, the user input reprocessing instructions 122 may provide one or more reinterpretations to output device(s) for presentation to the user.

Confidence Scoring and Determining the Most Probable Interpretation

In accordance with another aspect of the invention, confidence score instructions 124 may generate a confidence score that may relate to a likelihood of an interpretation being a correct interpretation of the user input, and the highest (or lowest) interpretation score may then be designated as a probable interpretation of the user input. In one implementation, confidence score instructions 124 may generate a confidence score for an initial interpretation representing the likelihood of the initial interpretation of the user input being correct. In another implementation, confidence score instructions 124 may also generate a confidence score for a reinterpretation representing the likelihood of the reinterpretation of the user input being correct.

In another implementation, confidence score instructions 124 may generate an intent confidence score that may relate to a likelihood of an interpretation sufficiently representing an intent of the user providing the user input, and the highest (or lowest) intent confidence score may then be designated as a sufficiently representing an intent of the user. In one implementation, confidence score instructions 124 may generate a confidence score for an initial interpretation representing the likelihood of an interpretation sufficiently representing an intent of the user. In another implementation, confidence score instructions 124 may also generate a confidence score for a reinterpretation representing the likelihood of an interpretation sufficiently representing an intent of the user.

In one implementation, confidence score instructions 124 may compare the confidence scores of the initial interpretation and the reinterpretation of the user input to determine the most probable interpretation of the user input. For example, confidence score instructions 124 may determine a confidence score for an initial interpretation of a user input and a confidence score for a reinterpretation of the same user input. The confidence score instructions 124 may utilize the confidence scores to select which of the initial interpretation or the reinterpretation is the most correct interpretation of the user input.

In another implementation, confidence score instructions 124 may compare the confidence scores of the initial interpretation and the reinterpretation to a confidence score threshold to determine an accuracy of an interpretation. For example, confidence score instructions 124 may compare the confidence score of the initial interpretation to determine an accuracy of the interpretation of the user input. In the case the confidence score of the initial interpretation does not satisfy a confidence score threshold, the confidence score instructions 124 may determine the initial interpretation is not an accurate interpretation of the user input. Confidence score instructions 124 may compare the confidence score of the reinterpretation to determine an accuracy of the reinterpretation of the user input. In the case the confidence score of the reinterpretation does not satisfy a confidence score threshold, the confidence score instructions 124 may determine the reinterpretation is not an accurate interpretation of the user input. In one implementation, confidence score instructions 124 may select either the initial interpretation or the reinterpretation if the interpretation satisfies the confidence score threshold. For example, if the initial interpretation and reinterpretation both satisfy the confidence score threshold, confidence score instructions 124 may select the interpretation with the highest confidence score. If either the initial interpretation or reinterpretation does not satisfy the confidence score threshold, confidence score instructions 124 may select the interpretation which satisfies the confidence score threshold. If both the initial interpretation and reinterpretation do not satisfy the confidence score threshold, confidence score instructions 124 may select the interpretation with the highest confidence score.

In an implementation, upon determination of a most probable interpretation of a user input, confidence score instructions 124 may determine an application suitable for executing the most probable interpretation, and provide the most probable interpretation to the application for further processing. For example, the most probable interpretation may be utilized to personalize tuning parameters associated with the input interpretation application, update one or more interpretation models, and the like. In one implementation, the confidence score instructions 124 may provide one or more probable interpretations to output device(s) for presentation to the user.

Examples of System Architectures and Configurations

Different system architectures may be used. For example, all or a portion of response instructions (or other instructions described herein) may be executed on a user device. In other words, computing device 110 as illustrated may include a user device operated by the user. In implementations where all or a portion of response instructions are executed on the user device, the user device may interface with user input processing instructions 118, user input storage instructions 120, user input reprocessing instructions 122, confidence score instructions 124, and/or other instructions, and/or perform other functions/operations of response instructions.

As another example, all or a portion of response instructions (or other instructions described herein) may be executed on a server device. In other words, computing device 110 as illustrated may include a server device that obtains a user input from a user device operated by the user. In implementations where all or a portion of response instructions are executed on the server device, the server may interface with user input processing instructions 118, user input storage instructions 120, user input reprocessing instructions 122, confidence score instructions 124, and/or other instructions, and/or perform other functions/operations of response instructions.

Although illustrated in FIG. 1 as a single component, computer system 104 may include a plurality of individual components (e.g., computer devices) each programmed with at least some of the functions described herein. In this manner, some components of computer system 104 may perform some functions while other components' may perform other functions, as would be appreciated. The processors 112 may each include one or more physical processors that are programmed by computer program instructions. The various instructions described herein are exemplary only. Other configurations and numbers of instructions may be used, so long as the processor(s) 112 are programmed to perform the functions described herein.

It should be appreciated that, although the various instructions are illustrated in FIG. 1 as being co-located within a single computing device 110, one or more instructions may be executed remotely from the other instructions. For example, some computing devices 110 of computer system 104 may be programmed by some instructions while other computing devices 110 may be programmed by other instructions, as would be appreciated. Furthermore, the various instructions described herein are exemplary only. Other configurations and numbers of instructions may be used, so long as processor(s) 112 are programmed to perform the functions described herein.

The description of the functionality provided by the different instructions described herein is for illustrative purposes and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor(s) 112 as well as data that may be manipulated by processor(s) 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configures hardware.

User device(s) may include a device that can interact with computer system 104 through network 102. Such user device(s) may include, without limitation, a tablet computing device, a smartphone, a laptop computing device, a desktop computing device, a network-enabled appliance such as a “smart” television, a vehicle computing device, and/or other device that may interact with computer system 104.

The various databases 132 described herein may be, include, or interface to, for example, an Oracle™ relational database sold commercially by Oracle Corporation. Other databases, such as Informix™, DB2 (Database 2), or other data storage, including file-based (e.g., comma- or tab-separated files) or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may comprise one or more such databases that reside in one or more physical devices and in one or more physical locations. The database may store a plurality of types of data and/or files and associated data or file descriptions, administrative information, or any other data. The database(s) 132 may be stored in storage device 114 and/or other storage that is accessible to computer system 104.

Example Flow Diagrams

The following flow diagrams describe operations that may be accomplished using some or all of the system components described in detail above, and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

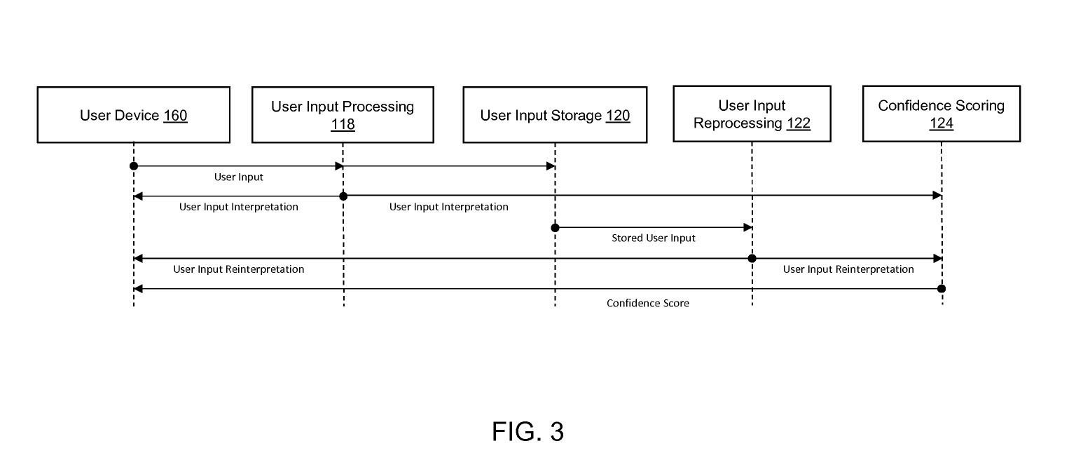

FIG. 3 illustrates a data flow for a process of interpreting natural language inputs based on storage of the inputs, in accordance with an implementation of the invention. The various processing data flows depicted in FIG. 3 (and in the other drawing figures) are described in greater detail herein. The described operations may be accomplished using some or all of the system components described in detail above, and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an implementation, a user input transmitted from a user device 160 may be received for user input processing 118. The user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. In response to receiving the user input, the user input processing 118 may provide an interpretation of the user input to the user device 160 and/or for confidence scoring 124, for example, if the user input may be processed to recognize one or more words of the user input. The recognized words may then be processed, along with context information associated with the user, to determine an interpretation of the user input. Furthermore, in response to receiving the user input, the user input may also be stored by user input storage 120. In response to receiving the stored user input, the user input reprocessing 122 may provide a reinterpretation of the user input to the user device 160 and/or for confidence scoring 124. The user input interpretation and user input reinterpretation may be provided to confidence scoring 124 to determine a likelihood of an interpretation being a correct interpretation of the user input. The confidence scores of the interpretation and the reinterpretation of the user input may be compared to determine the most probable interpretation of the user input.

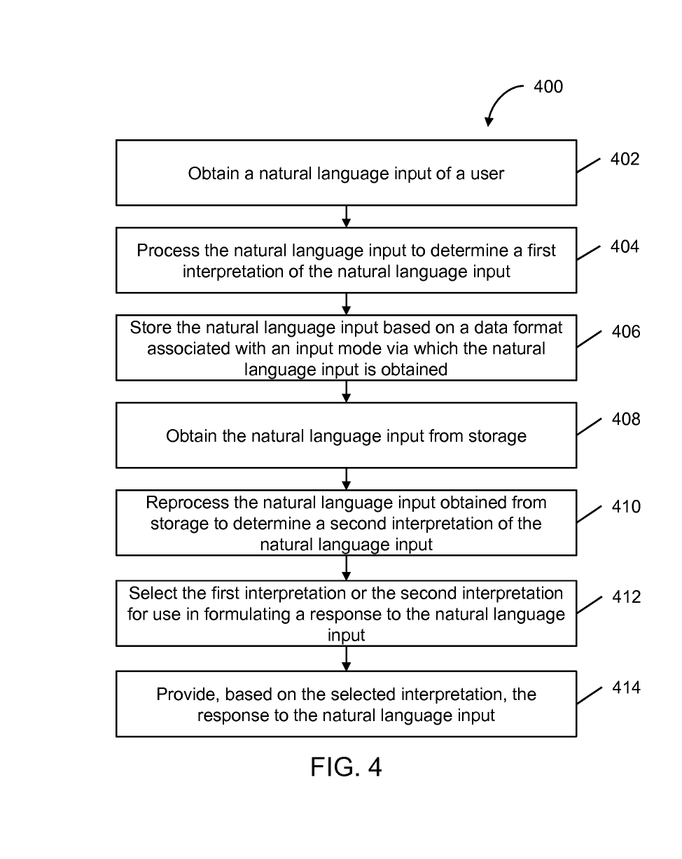

FIG. 4 illustrates a flow diagram for a method of interpreting natural language inputs based on storage of the inputs, in accordance with an implementation of the invention. The flows depicted in FIG. 4 (and in the other drawing figures) are described in greater detail herein. The described operations may be accomplished using some or all of the system components described in detail above, and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 402, a natural language input of a user may be obtained. The input may comprise an auditory input (e.g., received via a microphone), a visual input (e.g., received via a camera), a tactile input (e.g., received via a touch sensor device), an olfactory input, a gustatory input, a keyboard input, a mouse input, or other user input. The input may be obtained via an auditory input mode (e.g., a voice input mode), a video input mode, a text input mode, or other input mode.

In an operation 404, the natural language input may be processed to determine a first interpretation of the natural language input. For example, if the input is a natural language utterance spoken by a user, the natural language utterance may be processed to recognize one or more words of the natural language utterance. The recognized words may then be processed, along with context information associated with the user, by a natural language processing engine to determine the first interpretation of the input.

In an operation 406, the natural language input may be stored based on a data format associated with the input mode (via which the natural language input is obtained). As an example, with respect to auditory input, an audio file associated with an audio stream captured by an auditory input device may be stored for use in the event that the natural language input is to be reprocessed. The audio file may, for example, be cached or stored in a database.

In an operation 408, the natural language input may be obtained from storage. As an example, if the natural language input is stored as an audio file, the audio file may be obtained for reprocessing of the natural language input responsive to a determination that the first interpretation of the natural language input is not an accurate interpretation (e.g., a confidence score of the first interpretation does not satisfy an confidence score threshold designated as sufficiently representing the intent of the user in providing the input).

In an operation 410, the natural language input obtained from storage may be reprocessed to determine a second interpretation of the natural language input. In one implementation, if the input is stored as an audio file, the audio file may be obtained and utilized to reprocess the input.

In an operation 412, at least one of the first interpretation or the second interpretation of the natural language input may be selected for use in formulating a response to the natural language input. As an example, the response may comprise a prompt for additional information (e.g., if neither interpretation sufficiently represents the user's intent in providing the input, if neither interpretation satisfies a confidence score threshold, etc.), presentation of results related to a user request associated with the input, execution of actions related to a user request associated with the input, or other response.

In an operation 414, the response to the natural language input may be provided based on the selected interpretation (or interpretations) of the natural language input. As an example, if the selected interpretation is deemed not to be an accurate representation of the user's intent in providing the input, the user may be prompted to confirm whether the selected interpretation is accurate. As another example, if the selected interpretation indicates that the user provided the input to search for particular information (and is deemed to be an accurate representation of the user's intent in providing the input), the search may be performed, and the results of the search may be provided for presentation to the user.

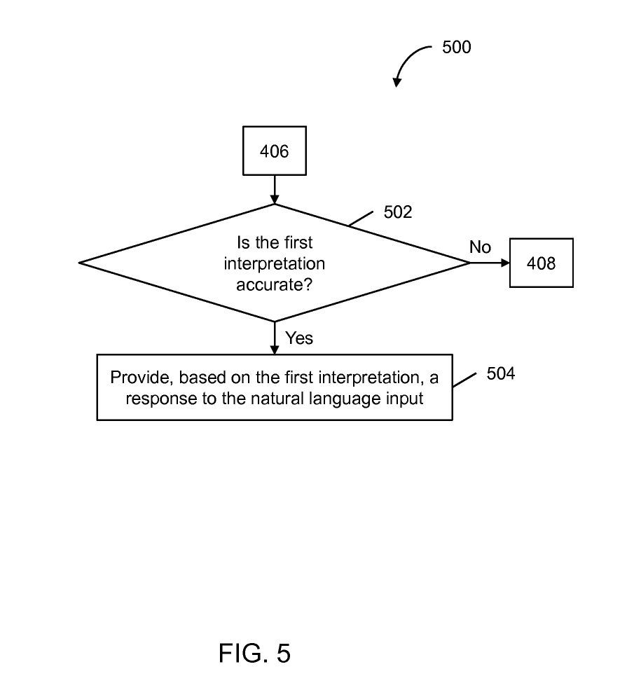

FIG. 5 illustrates a flow diagram for a method of determining whether to obtain and/or process a stored input to further interpret (or reinterpret) the input, in accordance with an implementation of the invention. The flows depicted in FIG. 5 (and in the other drawing figures) are described in greater detail herein. The described operations may be accomplished using some or all of the system components described in detail above, and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 502, a determination of whether a first interpretation of a natural language input is an accurate representation (of a user's intent in providing the input) may be effectuated. As an example, as shown in FIG. 4, the first interpretation may be determined in accordance with operations 402-404. Responsive to a determination that the first interpretation is an accurate representation, method 500 may proceed to operation 504. Otherwise, method 500 may proceed to operation 408 of FIG. 4.

In an operation 504, a response to the natural language input may be provided based on the first interpretation. As an example, the response may comprise a presentation of results related to a user request associated with the input, execution of actions related to a user request associated with the input, or other response based on the first interpretation.

Other implementations, uses, and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of interpreting natural language inputs based on storage of the inputs, the method being implemented on a computer system that includes one or more physical processors executing computer program instructions which, when executed by the one or more physical processors, perform the method, the method comprising:
obtaining, by the computer system, a natural language input of a user, wherein the natural language input is initially obtained via an input mode;
processing, by the computer system, the natural language input to determine a first interpretation of the natural language input;
storing, by the computer system, the natural language input based on a data format associated with the input mode;
obtaining, by the computer system, the natural language input from storage; and
reprocessing, by the computer system, the natural language input obtained from storage to determine a second interpretation of the natural language input.

2. The method of claim 1, wherein the natural language input comprises a natural language utterance of the user, and the data format comprises an audio format, and
wherein storing the natural language input comprises storing the natural language utterance based on the audio format.

3. The method of claim 1, wherein the data format comprises a file format,
wherein storing the natural language input comprises storing, based on the file format, the natural language input as a file,
wherein obtaining the natural language input from storage comprises obtaining the file from storage, and
wherein reprocessing the natural language input comprises processing the file to determine the second interpretation.

4. The method of claim 3, wherein storing the natural language input comprises storing, based on the file format, the natural language input as a file in a database, and
wherein obtaining the natural language input from storage comprises obtaining the file from the database.

5. The method of claim 3, wherein storing the natural language input comprises storing, based on the file format, the natural language input as a file in a cache, and
wherein obtaining the natural language input from storage comprises obtaining the file from the cache.

6. The method of claim 5, wherein the cache comprises a disk cache,
wherein storing the natural language input comprises storing, based on the file format, the natural language input in the disk cache, and
wherein obtaining the natural language input from the cache comprises obtaining the file from the disk cache.

7. The method of claim 1, wherein natural language input comprises a natural language utterance, and the data format comprises an audio format,
wherein processing the natural language input comprises (i) performing speech recognition on the natural language utterance to recognize one or more first words of the natural language utterance, and (ii) determining the first interpretation based on the one or more first words,
wherein storing the natural language input comprises storing the natural language utterance based on the audio format, and
wherein reprocessing the natural language input comprises (i) performing speech recognition on the natural language utterance obtained from storage to recognize one or more second words of the natural language utterance, and (ii) determining the second interpretation based on the one or more second words.

8. The method of claim 7, wherein the audio format comprises an audio file format,
wherein storing the natural language utterance comprises storing, based on the audio file format, the natural language utterance as an audio file,
wherein obtaining the natural language input from storage comprises obtaining the audio file from storage, and
wherein reprocessing the natural language input comprises (i) processing the audio file to extract audio signals representing the natural language utterance, (ii) performing speech recognition on the audio signals to recognize the one or more second words, and (iii) determining the second interpretation based on the one or more second words.

9. The method of claim 1, further comprising:
selecting, by the computer system, at least one of the first interpretation or the second interpretation; and
providing, by the computer system, a response to the natural language input based on the at least one selected interpretation.

10. The method of claim 9, further comprising:
generating, by the computer system, a confidence score for the first interpretation that represents the likelihood of the first interpretation being an accurate interpretation; and
generating, by the computer system, a confidence score for the second interpretation that represents the likelihood of the second interpretation being an accurate interpretation,
wherein selecting at least one of the first interpretation or the second interpretation comprises selecting at least one of the first interpretation or the second interpretation based on a comparison of the confidence score for the first interpretation and the confidence score for the second interpretation.

11. The method of claim 1, further comprising:
determining, by the computer system, whether the first interpretation sufficiently represents an intent of the user in providing the natural language input,
wherein obtaining the natural language input from storage comprises obtaining the natural language input from storage responsive to a determination that the first interpretation does not sufficiently represent the intent of the user in providing the natural language input, and
wherein reprocessing the natural language input comprises reprocessing the natural language input obtained from storage responsive to the determination that the first interpretation does not sufficiently represent the intent of the user in providing the natural language input.

12. The method of claim 11, further comprising:
generating, by the computer system, a confidence score for the first interpretation that represents the likelihood of the first interpretation being an accurate interpretation; and
determining, by the computer system, whether the confidence score for the first interpretation satisfies a confidence score threshold,
wherein the determination that the first interpretation does not sufficiently represent the intent of the user in providing the natural language input is based on a determination that the confidence score for the first interpretation does not satisfy the confidence score threshold.

13. The method of claim 12, further comprising:
generating, by the computer system, a confidence score for the second interpretation that represents the likelihood of the second interpretation being an accurate interpretation;
selecting, by the computer system, at least one of the first interpretation or the second interpretation based on a comparison of the confidence score for the first interpretation and the confidence score for the second interpretation; and
providing, by the computer system, a response to the natural language input based on the at least one selected interpretation.

14. A system of interpreting natural language inputs based on storage of the inputs, the system comprising:
one or more physical processors programmed with computer program instructions which, when executed, cause the one or more physical processors to:
obtain a natural language input of a user, wherein the natural language utterance is initially obtained via an input mode;
process the natural language input to determine a first interpretation of the natural language input;
store the natural language input based on a data format associated with the input mode;
obtain the natural language input from storage; and
reprocess the natural language input obtained from storage to determine a second interpretation of the natural language input.

15. The system of claim 14, wherein the natural language input comprises a natural language utterance of the user, and the data format comprises an audio format,
wherein storing the natural language input comprises storing the natural language utterance based on the audio format.

16. The system of claim 14, wherein the data format comprises a file format,
wherein storing the natural language input comprises storing, based on the file format, the natural language input as a file,
wherein obtaining the natural language input from storage comprises obtaining the file from storage, and
wherein reprocessing the natural language input comprises processing the file to determine the second interpretation.

17. The system of claim 14, wherein natural language input comprises a natural language utterance, and the data format comprises an audio format,
wherein processing the natural language input comprises (i) performing speech recognition on the natural language utterance to recognize one or more first words of the natural language utterance, and (ii) determining the first interpretation based on the one or more first words,
wherein storing the natural language input comprises storing the natural language utterance based on the audio format, and
wherein reprocessing the natural language input comprises (i) performing speech recognition on the natural language utterance obtained from storage to recognize one or more second words of the natural language utterance, and (ii) determining the second interpretation based on the one or more second words.

18. The system of claim 17, wherein the audio format comprises an audio file format, and
wherein storing the natural language utterance comprises storing, based on the audio file format, the natural language utterance as an audio file,
wherein obtaining the natural language input from storage comprises obtaining the audio file from storage, and
wherein reprocessing the natural language input comprises (i) processing the audio file to extract audio signals representing the natural language utterance, (ii) performing speech recognition on the audio signals to recognize the one or more second words, and (iii) determining the second interpretation based on the one or more second words.

19. The system of claim 14, wherein the computer program instructions further cause the one or more physical processors to:
determine whether the first interpretation sufficiently represents an intent of the user in providing the natural language input,
wherein obtaining the natural language input from storage comprises obtaining the natural language input from storage responsive to a determination that the first interpretation does not sufficiently represent the intent of the user in providing the natural language input, and
wherein reprocessing the natural language input comprises reprocessing the natural language input obtained from storage responsive to the determination that the first interpretation does not sufficiently represent the intent of the user in providing the natural language input.

20. The method of claim 19, wherein the computer program instructions further cause the one or more physical processors to:
generate a confidence score for the first interpretation that represents the likelihood of the first interpretation being an accurate interpretation; and
determine whether the confidence score for the first interpretation satisfies a confidence score threshold,
wherein the determination that the first interpretation does not sufficiently represent the intent of the user in providing the natural language input is based on a determination that the confidence score for the first interpretation does not satisfy the confidence score threshold.
